(19) United States
(12) Patent Application Publication
(10) Pub. No.: US 2008/0172149 A1
(43) Pub. Date: Jul. 17, 2008

(54) Device For Assisting a Vertical Guidance Approach For Aircraft

(75) Inventors: Patrice Rouquette, Pompertuzat (FR); Adrien Ott, Fresnes (FR); Laure Maes, Toulouse (FR); Caroline Aucher, Saint Jean (FR); Melanie Bats, Toulouse (FR); Gregory Ortet, Toulouse (FR)

Correspondence Address: STEVENS DAVIS LLP, 1615 L STREET NW, SUITE 850, WASHINGTON, DC, 20036, US

(73) Assignee: AIRBUS FRANCE, Toulouse (FR)

(21) Appl. No.: 11/994,979

(22) PCT Filed: Jul. 11, 2006
(86) PCT No.: PCT/FR2006/001682

§ 371 Date: Jan. 7, 2008

(30) Foreign Application Priority Data
Jul. 13, 2005 (FR) 0507504

(51) Int. Cl. G05D 1/00

(52) U.S. Cl. 701/16

(57) ABSTRACT

The invention concerns an approach assisting device (1) comprising a flight management system (2) which determines an approach paths, an inertial reference system (3) which prepares inertial position data, which receives position data of the aircraft, and which determines a hybrid position of said aircraft, a landing assisting multimode receiver (4) which receives data concerning said approach path and said hybrid position, and which deduces therefrom lateral and vertical angular differences, at least when said approach axis is captured, and a guiding system (7) which receives said lateral and vertical angular differences and uses same for guiding the aircraft, at least when said approach path is captured.

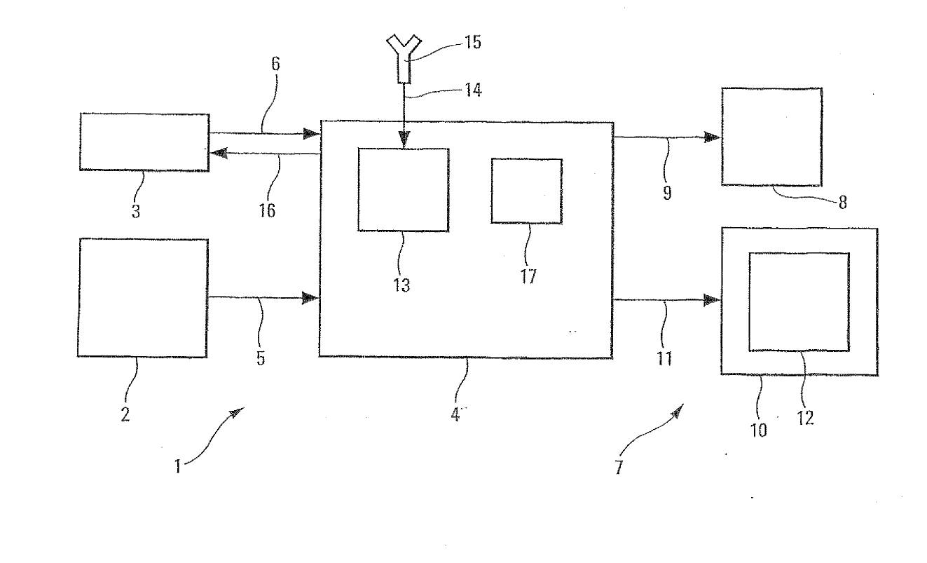

The present invention relates to a device for assisting an approach, which is mounted on an aircraft, in particular a transport airplane, and which is intended to assist said aircraft at least during an approach with vertical guidance.

It is known that the current published approaches, with a view to the landing of an airplane on a landing runway, are divided into two categories:

the so-called “non precision” approaches, for which no vertical performance rating requirement is imposed; and

the so-called “precision” approaches, such as for example an approach of ILS (“Instrument Landing System”) type, for which lateral and vertical performance rating requirements are imposed.

Precision approaches exhibit lower decision heights to be complied with than non precision approaches.

The performance ratings of the aircraft to be taken into account during an approach depend, in particular, on the precision of the current position of the aircraft, which is determined in a periodic manner in the course of the flight. This current position is determined in general on the basis of position data which are generated by at least one onboard receiver which cooperates with a standard satellite-based global positioning system, for example of OPS (“Global Positioning System”) type or of GALILEO type.

It is additionally known that there exist augmentation means, for example of GNSS type (“Global Navigation Satellite System”), the aim of which is to improve the performance ratings of the receiver used, which cooperates with a satellite-based positioning system. The use of such augmentation means has given rise to the emergence of new approaches based solely on performance rating criteria. These new approaches lie between the aforesaid precision approaches and non precision approaches. These new approaches are termed “approaches with vertical guidance” or APV approaches, These APV approaches exhibit two different predetermined performance levels: APV1 and APV2. The decision heights associated with these two performance levels lie between the decision heights of the precision approaches and the decision heights of the non precision approaches.

It is known that the GNSS augmentation means consist in improving the performance ratings of the satellite-based positioning system used (precision, integrity, service continuity and availability), and comprise systems acting by way of ground stations of GPAS (“Ground Based Augmentation System”) type or by way of geostationary satellites of SPAS (“geostationary Satellite Based Augmentation System”) type, or systems making an autonomous improvement, that is to say which is implemented exclusively with the assistance of means present aboard the aircraft of ABAS (“Airborne Based Augmentation System”) type.

Augmentation systems of GPAS and SBAS type therefore require the use of exterior elements, while an augmentation system of ABAS type is completely autonomous. The latter is therefore to be favored, all the more so since a system of SEAS type for example is not usable over the whole of the terrestrial globe, since the associated network of ground stations exhibits only partial coverage of the terrestrial globe.

The present invention relates to a device for assisting an approach which is mounted on an aircraft, in particular an airplane, for example a transport airplane, and which is intended to assist said aircraft, in an autonomous and particularly efficacious manner, at least during an approach with vertical guidance of aforesaid APV type following an approach axis.

For this purpose, according to the invention, said device for assisting an approach is noteworthy in that it comprises:

a flight management system which determines said approach axis;

an inertial reference system, which formulates inertial position data, which receives GNSS position data of the aircraft, and which, with the assistance of said position data received and of said formulated inertial position data, determines a hybrid position of the aircraft. Within the framework of the present invention, this position is called the “hybrid position”, since it is obtained on the basis of different types of data (position data, inertial position data), as specified below;

a multimode landing assistance receiver, for example of MMR (“Multi Mode Receiver”) type, which is connected to said flight management system and to said inertial reference system, which receives information relating to said approach axis and to said hybrid position, and which deduces therefrom lateral and vertical angular deviations, at least as soon as said approach axis is captured; and

a guidance system which is connected to said multimode landing assistance receiver and which receives said lateral and vertical angular deviations and uses them for the guidance of the aircraft, at least as soon as said approach axis is captured.

Said device for assisting an approach in accordance with the invention is therefore autonomous (of aforesaid ABAS type), since the means used to allow an approach with vertical guidance are all situated aboard the aircraft.

Moreover, by virtue of the invention, said flight management system, for example of FMS (“Flight Management System”) type, is situated outside the guidance loop during the guidance of the aircraft along said approach axis with a view to landing. This presents several advantages and makes it possible in particular, as specified below:

to obtain a position of the aircraft that is more precise and sounder than that obtained in a standard manner by said flight management system of FMS type, since only high development level systems (inertial reference system, multimode landing assistance receiver, guidance system) are used in the position/guidance loop, this not being the case for the flight management system of FMS type;

to reduce the latency times due to the transfer of the positioning information in the navigation/guidance loop; and

to improve the vertical and horizontal precision and integrity.

In particular, to increase the precision of the assistance afforded by the device in accordance with the invention, said inertial reference system uses a particularly efficacious algorithm to calculate said hybrid position of the aircraft. More precisely, it uses a standard hybridization algorithm termed “precision-AIME” which presents numerous advantages (precision, continuity, etc.). It will be noted that the integrity of the approach axis data is ensured by a cyclic redundant monitoring, of CRC (“Cyclic Redundancy Check”) type, in the multimode landing assistance receiver.

In a particular embodiment, said guidance system comprises:

means, for example an automatic pilot, for automatically guiding the aircraft, by taking account of said lateral and vertical angular deviations determined by the multimode landing assistance receiver; and/or

at least one viewing means for displaying, on at least one viewing screen, said lateral and vertical angular deviations arising from said multimode landing assistance receiver and from the guidance indications relating to said angular deviations.

Thus, the device for assisting an approach in accordance with the invention makes it possible to afford assistance both during automatic guidance and during manual guidance.

In a particular embodiment, said device comprises, moreover, a receiver:

which cooperates with a satellite-based positioning system, for example of GPS or other type;

which is integrated within said multimode landing assistance receiver; and

which formulates said position data for the aircraft which are thereafter transmitted at least to said inertial reference system.

Furthermore, in a preferred embodiment, said multimode landing assistance receiver comprises an integrated monitoring means, which monitors performance parameters relating to the hybrid position provided by said inertial reference system, and which transmits the results of this monitoring (in general via a guidance means which consolidates them) to a viewing means which is capable of presenting these results to a pilot of the aircraft. Consequently, as a function of the actual performance ratings (in particular vertical) thus provided, the pilot is warned of the aircraft's ability to carry out (or not) an approach with vertical guidance of APV type.

In this case, preferably, said monitoring means can emit results which relate respectively to the following situations:

a first predetermined performance rating (or performance level) APV2, relating to said approach with vertical guidance, is upheld by the aircraft;

said first performance rating APV2 is not upheld by the aircraft, but a second less strict performance rating (or performance level) APV1, also relating to said approach with vertical guidance, is upheld by the aircraft;

said second performance rating APV1 is not upheld by the aircraft, but the approach can nevertheless be continued; and

the performance ratings are insufficient to continue the approach.

Additionally, in a particular embodiment, said flight management system determines an auxiliary position corresponding to the position of the aircraft and, before said approach axis is captured, said device for assisting an approach in accordance with the invention uses this auxiliary position, in a standard manner, to guide the aircraft. Thus, before the approach axis is captured, the guidance of the aircraft is carried out in a standard manner, that is to say with the assistance of the position calculated by the flight management system. As regards the hybrid position determined by the inertial reference system, it is taken into account right from the start of the capture of the approach axis. The (in particular vertical) performance ratings relating to this position, must make it possible to comply with the aforesaid performance levels APV1 or APV2, making it possible to implement an approach with vertical guidance of APV type.

The single FIGURE or the appended drawing will elucidate the manner in which the invention may be carried out, This single FIGURE is the schematic diagram of a device for assisting an approach in accordance with the invention.

The device 1 in accordance with the invention and schematically represented in the FIGURE, is intended to assist an aircraft (not represented), in particular an airplane, during an approach to an airport with a view to a landing on a landing runway. More precisely, said device 1 is intended to assist the aircraft at least during an approach with vertical guidance of the known APV (“Approach with Vertical guidance”) type. Such an APV approach (which relates to an approach following an approach axis) is intermediate between a precision approach and a non precision approach. Moreover, an APV approach such as this exhibits in a known manner two different predetermined performance levels: APV 1 and APV2. The decision heights associated with these two performance levels APV1 and APV2 lie between the decision heights of the precision approaches and the decision heights of the non precision approaches. By way of illustration, as regards the horizontal navigation precision (95%), the requirements are:

220 meters for a non precision approach;

16 meters for performance level APV1;

16 meters for performance level APV2; and

16 meters for a precision approach.

Moreover, as regards the vertical navigation precision (95%), the requirements are:

not applicable for a non precision approach (absence of vertical navigation precision requirement);

20 meters for performance Level APV1;

8 meters for performance level APV2; and

from 4 to 6 meters for a precision approach.

According to the invention, said device 1 comprises:

a flight management system 2, preferably of FMS (“Flight Management System”) type, which determines in a standard manner the approach axis along which the approach is carried out. In a standard manner, during an approach phase, the aircraft is first of all guided so as to capture this approach axis, that is to say to join it, then, as soon as it has captured this approach axis, to follow it up to landing;

an inertial reference system 3, for example of ADIRS (“Air Data Inertial Reference System”) type, which formulates inertial position data in a standard manner, which moreover receives position data for the aircraft, as specified below, and which, with the assistance of the position data received and of the formulated inertial position data, determines a position of the aircraft termed the hybrid position. Within the framework of the present invention, one speaks of “hybrid position”, since the position of the aircraft is determined (in a standard manner) on the basis of different types of data (position date, inertial position data);

a multimode landing assistance receiver 4, preferably of MMR (“Multi Mode Receiver”) type, which is connected to said flight management system 2 by way of a link 5 and to said inertial reference system 3 by way of a link 6, which receives information relating to said approach axis and to said hybrid position respectively of said systems 2 and 3, and which in a standard manner deduces therefrom possible lateral and vertical angular deviations; and

a guidance system 7, specified below, which receives said lateral and vertical angular deviations determined by said multimode landing assistance receiver 4 and which uses these deviations for the guidance of the aircraft, doing so as soon as said approach axis is captured.

Said device for assisting an approach 1 in accordance with the invention is therefore autonomous (of aforesaid ABAS type), since the means used to allow an approach with vertical guidance (APV approach) are all situated aboard the aircraft.

Moreover, by virtue of the invention, the flight management system 2, for example of FMS (“Flight Management System”) type, is situated outside the guidance loop during the guidance of the aircraft along said approach axis with a view to landing. This exhibits several advantages and makes it possible in particular:

to obtain a position of the aircraft that is more precise and sounder than that obtained in a standard manner by said flight management system 2, since only high development level systems (inertial reference system 3, multimode landing assistance receiver 4, guidance system 7) are thus used in the position/guidance loop, this not being the case for the flight management system 2;

to reduce the latency times due to the transfer of the positioning information in the navigation/guidance loop; and

to improve the vertical precision and integrity.

In a particular embodiment, said flight management system 2 determines an auxiliary position corresponding to the position of the aircraft and, before said approach axis is captured, said device for assisting an approach 1 in accordance with the invention uses, in a standard manner, this auxiliary position to guide the aircraft. Thus, before the approach axis is captured, the guidance of the aircraft is carried out in a standard manner, that is to say with the assistance of the position calculated by the flight management system 2. As regards the hybrid position determined by the inertial reference system 3, it is taken into account right from the start of the capture of the approach axis. The (in particular vertical) performance ratings relating to this position, must make it possible to comply with the aforesaid performance levels APV1 or APV2, permitting the implementation of an approach with vertical guidance of APV type.

It will be noted that said multimode landing assistance receiver 4 comprises, in a standard manner:

at least one first transverse edge function, for example of ILS, MLS or GLS type, making it possible to implement a precision approach; and

a transverse edge function, for example of FLS (“FMS Landing System”) type making it possible to carry out a non precision approach.

Consequently, said multimode landing assistance receiver 4 is able to allow the implementation of any type of approach (precision, non precision, APV).

Additionally, in a particular embodiment, said guidance system 7 can comprise:

means 8, for example an automatic pilot, which is connected by way of a link 9 to said receiver 4 and which is formed so as to automatically guide the aircraft, by taking account of the lateral and vertical angular deviations received from said receiver 4; and

at least one viewing means 10 which is connected by way of a link 11 to said receiver 4 and which is able to display, on at least one viewing screen 12 installed in the flight deck of the aircraft, information relating to said lateral and vertical angular deviations (and guidance indications relating to said deviations). Thus, the pilot is able to ascertain these deviations and possibly to carry out manual guidance so as to zero them. This viewing means 10 can in particular be a display means of EIS (“Electronic Instrument System”) type or a flight alert system of FWS (“Flight Warning System”) type.

Thus, the device 1 in accordance with the invention makes it possible to afford assistance both during automatic guidance (means 8) and during manual guidance (viewing means 10).

Additionally, in a particular embodiment, said device 1 moreover comprises a receiver 13:

which cooperates with a standard satellite-based positioning system, for example of GPS or other type; which is connected by way of a link 14 to an antenna 15 which is for example installed on the roof of the aircraft;

which is directly integrated within said multimode landing assistance receiver 4; and

which formulates, in a standard manner, with the assistance of signals received from the antenna 15, said position data for the aircraft which are thereafter transmitted, at least to said inertial reference system 3 by way of a link 16.

In a preferred embodiment, said inertial reference system 3, for example of ADIRU (“Air Data/Inertial Reference Unit”) type, uses a standard hybridization algorithm of “precision-AIME” type to determine the current hybrid position of the aircraft. Such a “precision-AIME” algorithm is particularly precise (generally ±6 meters horizontally, and ±9 meters vertically) and very efficacious. Such use makes it possible to increase the precision of the device for assisting an approach 1 in accordance with the invention.

Furthermore, in a particular embodiment, said multimode landing assistance receiver 4 comprises, moreover, an integrated monitoring means 17. This monitoring means 17 monitors performance parameters relating to the hybrid position provided by said inertial reference system 3. The results of this monitoring are transmitted to a viewing means (for example to the viewing means 10) which is capable of presenting these results to a pilot of the aircraft. It will be noted that the monitoring means 17 of the multimode landing assistance receiver 4 does not transmit the results of its monitoring directly to the viewing means, but to a standard guidance means which consolidates them, then dispatches them to said viewing means. Consequently, as a function of the actual performance ratings (in particular vertical) thus provided, the pilot is warned of the aircraft's ability to carry out (or not) an approach with vertical guidance of APV type.

In this case, preferably, said monitoring means 17 can provide results which relate respectively to the following situations:

the predetermined performance rating (or performance level) APV2, relating to said approach with vertical guidance APV, is upheld by the aircraft;

said performance rating APV2 is no longer upheld by the aircraft, but the less strict performance rating (or performance level) APV1, also relating to said approach with vertical guidance APV, is upheld by the aircraft;

said performance rating APV1 is no longer upheld by the aircraft, but the approach can nevertheless be continued; and

the performance ratings are insufficient to continue the approach.

1-8. (canceled)

9. A device for assisting an approach which is mounted on an aircraft and which is intended to assist said aircraft at least during an approach with vertical guidance following an approach axis, said device (1) comprising a guidance system (7) which receives lateral and vertical deviations and uses them for the guidance of the aircraft, wherein it comprises, moreover:
a flight management system (2) which determines said approach axis;
an inertial reference system (3) which formulates inertial position data, which receives position data for the aircraft, and which, with the assistance of said position data received and of said formulated inertial position data, determines a hybrid position of the aircraft; and
a multimode landing assistance receiver (4) which is connected to said flight management system (2) and to said inertial reference system (3), which receives information relating to said approach axis and to said hybrid position, which deduces therefrom lateral and vertical angular deviations, at least as soon as said approach axis is captured, and which transmits these angular deviations to said guidance system (7).

10. The device as claimed in claim 9, wherein said guidance system (7) comprises means (8) for automatically guiding the aircraft, by taking account of said lateral and vertical angular deviations.

11. The device as claimed in claim 9, wherein said guidance system (7) comprises at least one viewing means (10) for displaying, on at least one viewing screen (12), said lateral and vertical angular deviations arising from said multimode landing assistance receiver (4) and from the guidance indications relating to said deviations.

12. The device as claimed in claim 9, wherein it comprises, moreover, a receiver (13) which cooperates with a satellite-based positioning system, which is integrated within said multimode landing assistance receiver (4), and which formulates said position data for the aircraft which are thereafter transmitted at least to said inertial reference system (3).

13. The device as claimed in claim 9, wherein said multimode landing assistance receiver (4) comprises an integrated monitoring means (17), which monitors performance parameters relating to the hybrid position provided by said inertial reference system (3), the results of this monitoring being transmitted to a viewing means which is capable of presenting these results to a pilot of the aircraft.

14. The device as claimed in claim 13, wherein said monitoring means (17) is capable of emitting results which relate respectively to the following situations:
a first predetermined performance rating APV2, relating to said approach with vertical guidance, is upheld by the aircraft;
said first performance rating APV2 is not upheld by the aircraft, but a second less strict performance rating APV1, also relating to said approach with vertical guidance, is upheld by the aircraft;
said second performance rating APV1 is not upheld by the aircraft, but the approach can nevertheless be continued; and
the performance ratings are insufficient to continue the approach.

15. The device as claimed in claim 9, wherein said flight management system (2) determines an auxiliary position corresponding to the position of the aircraft and, before said approach axis is captured, said device for assisting an approach (1) uses this auxiliary position to guide the aircraft.

16. An aircraft, wherein it comprises a device for assisting an approach (1) such as that specified under claim 9.
